(19) United States
(12) Patent Application Publication
(10) Pub. No.: US 2004/0216138 A1
(43) Pub. Date: Oct. 28, 2004

(54) Method and system for processing input from a command line interface

(75) Inventors: Igor Pankovcin, Redmond, WA (US); Phillip Daniel Chadwick Patton, Redmond, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA (US)

(21) Appl. No.: 09/839,108

(22) Filed: Apr. 20, 2001

(51) Int. Cl. G06F 9/00; G06F 9/46

(52) U.S. Cl. 719/320; 710/5

(57) ABSTRACT

A method and system for processing input from a command line is provided, in which the command line contains a macro that gets parsed by a command line processor. The processor replaces the macro with the appropriate command and executes the command line. The macro may contain a message that the processor displays to prompt the user to identify the command that is to replace the macro. Other possible functions that the macro may perform include, but are not limited to: executing a function to generate a string to replace the macro, executing a function to generate another macro with which the first macro may be replaced, and prompting the user to enter the name of a dynamic-linked library (DLL) from which the replacement string for the macro may be obtained.

### TECHNICAL FIELD

This invention relates generally to command line processing and, more particularly, to the use of macros in command line processing.

### BACKGROUND OF THE INVENTION

A command line interface is a user interface to a program that allows a user to directly input lines of text, hereinafter referred to as “command lines,” that include commands and any required parameters. The program then responds to the input by acting on the commands. The user may manually input command lines one at a time directly into a keyboard, or store several command lines in a file, such as a batch file, that can then automatically be input to the command line interface. A well-known example of a command line interface is the MICROSOFT Disk Operating System (MS-DOS) prompt.

Conventional command line interfaces are very easy to implement and require minimal overhead, but are limited in functionality. One limitation is that command line interfaces do not allow input parameters to be flexibly defined. In other words, if a user wishes to change the parameters input via the command line interface, he or she may be required to reenter then manually, or incorporate them into a new version of an executable file.

One area in which command line interfaces are frequently used is software testing. To run a software test, a test engineer typically enters the name of a batch file on the command line. The batch file then causes a series of commands to be entered. For example, the batch file may have the following series of commands:

Dir c:\test

Set param1=0

Mytest param2 param3 testlog.txt.

These commands change the current disk directory to “test,” set the value of “param1,” and execute the program “mytest.exe” with “param2 and param3” as inputs, and with the results of the test being stored in “testlog.txt.” If the test engineer wishes to make changes in the test itself, he or she may have code the new test and recompile it as “test.exe.” Similarly, to change one or more of the input parameters, the test engineer may have to manually edit the batch file. Both of these procedures can be very cumbersome, especially if the test engineer needs to run dozens of variations of the test.

Thus, it can be seen that there is a need for a method and system for processing command line input that avoids these limitations.

### SUMMARY OF THE INVENTION

In accordance with the foregoing, a method and system for processing input from a command line is provided, in which the command line contains a macro that gets parsed by a command line processor. The processor replaces the macro with the appropriate command and executes the command line. The macro may contain a message that the processor displays to prompt the user to identify the command that is to replace the macro. Other possible functions that the macro may perform include, but are not limited to: executing a function to generate a string to replace the macro, executing a function to generate another macro with which the first macro may be replaced, and prompting the user to enter the name of a dynamic-linked library (DLL) from which the replacement string for the macro may be obtained.

Additional features and advantages of the invention will be made apparent from the following detailed description of illustrative embodiments that proceeds with reference to the accompanying figures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is an example of a network;

FIG. 2 is an example of a computer;

FIG. 3 is an example of an architecture that may be used in an embodiment of the invention;

FIG. 4 is a flowchart showing steps that may be executed in an embodiment of the invention; and,

FIG. 5 is an example of command line files that may be used in a software test scenario according to an embodiment of the invention.

### DETAILED DESCRIPTION OF THE INVENTION

The invention is generally directed to a method and system for processing a command line from a command line interface that allows macros to be included within the text of command line. The macros may be expanded to generate commands and parameters that are included in the command line.

Although it is not required, the invention may be implemented by computer-executable instructions, such as program modules, that are executed by a computer. Generally, program modules include routines, programs, objects, components, data structures and the like that perform particular tasks or implement particular abstract data types.

The invention may be implemented on a variety of types of computers, including personal computers (PCs), hand-held devices, multi-processor systems, microprocessor-based on programmable consumer electronics, network PCs, minicomputers, mainframe computers and the like. The invention may also be employed in distributed computing environments, where tasks are performed by remote processing devices that are linked through a communications network. In a distributed computing environment, modules may be located in both local and remote memory storage devices.

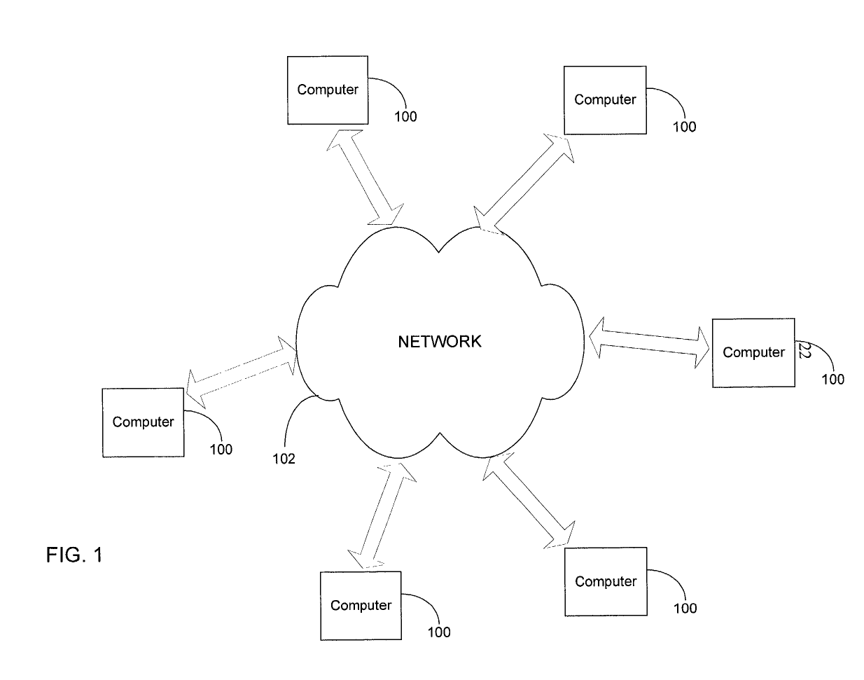

An example of a networked environment in which this system may be used will now be described with reference to FIG. 1. The example network includes several computers 100 communicating with one another over a network 102, represented by a cloud. Network 102 may include many well-known components, such as routers, gateways, hubs, etc. and may allow the computers 100 to communicate via wired and/or wireless media.

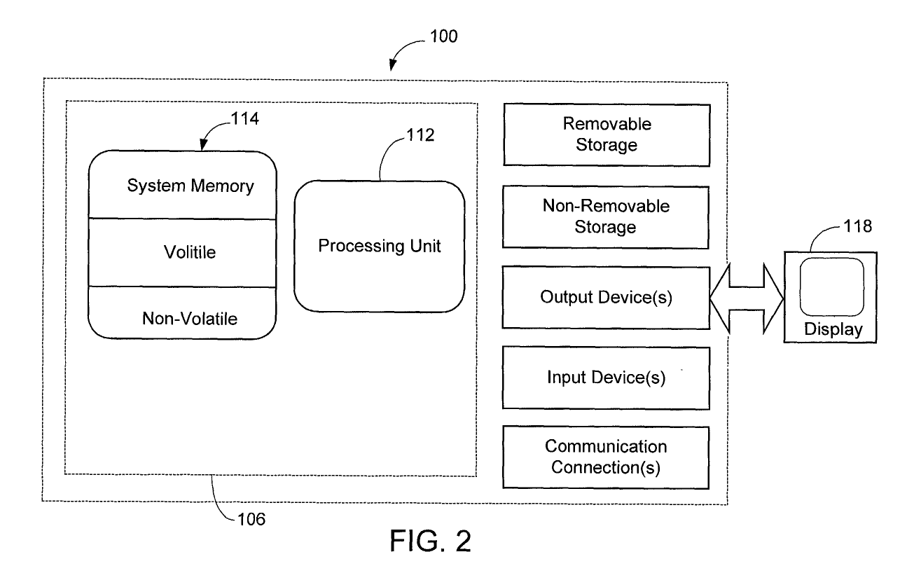

Referring to FIG. 2, an example of a basic configuration for a computer on which the system described herein may be implemented is shown. In its most basic configuration, the computer 100 typically includes at least one processing unit 112 and memory 114. Depending on the exact configuration and type of the computer 100, the memory 114 may be volatile (such as RAM), non-volatile (such as ROM or flash memory) or some combination of the two. This most basic configuration is illustrated in FIG. 2 by dashed line 106. Additionally, the computer may also have additional features/functionality. For example, computer 100 may also include additional storage (removable and/or non-removable) including, but not limited to, magnetic or optical disks or tape. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to stored the desired information and which can be accessed by the computer 100. Any such computer storage media may be part of computer 100.

Computer 100 may also contain communications connections that allow the device to communicate with other devices. A communication connection is an example of a communication medium. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. The term computer readable media as used herein includes both storage media and communication media.

Computer 100 may also have input devices such as a keyboard, mouse, pen, voice input device, touch input device, etc. Output devices such as a display 1 16, speakers, a printer, etc. may also be included. All these devices are well known in the art and need not be discussed at length here.

The invention may include the use of many different types of macros. In one embodiment, a macro may be used to call a run-time line library from within the command line. Functions of the run-time library can then be used to generate new commands and new parameters for the command line. For example, a programmer may wish to write a batch file having a series of command lines that, when executed, cause a computer to enter the proper disk directory and to run a particular program. The conventional format of these command lines in the MS-DOS environment is:

dir c:\MyDirectory

MyProgram.exe

However, there may be times that the programmer won't know in advance the directory in which “MyProgram.exe” is located. It may therefore be necessary for the programmer to run a special function that checks the system registry to determine where “MyProgram.exe” is located. An embodiment of the invention allows the programmer to insert a macro into the “dir” command line that, when expanded, executes a run-time library function to retrieve the directory path from the system registry and substitute the correct path for the macro. For example, the batch file may look like this:

dir<function name>

MyProgram.exe

A command line processor operating in accordance with this embodiment of the invention identifies the macro by the brackets and calls the function whose name is inside the brackets. The function then searches the system registry and finds the name of the directory in which “MyProgram.exe” is located. The function returns the name to the command line processor. The command line processor then substitutes the directory name for the macro. After the macro has been expanded, the batch file now looks like this:

dir c:\MyDirectory

MyProgram.exe.

The command lines inside the batch file can now be executed properly.

In another embodiment of the invention, a macro is used on a command line to display the dialog box that allows the user to enter information at the time the command line is processed. The information can then be included in the command line prior to the command line being executed. To illustrate this feature, the previous batch file example will be modified slightly. It is assumed in this example that the programmer does not know the directory in which “MyProgram.exe” is located. However, it is assumed that the programmer does not need to run a special function to obtain the name of the directory, but instead can obtained it verbally from a colleague. The batch file may initially look like this:

Dir<dialog box “Please type in name of directory”>

MyProgram.exe

When processing the command lines of the batch file, the command line processor displays a dialog box with the message “please type in name of directory.” The user then types in the name of “c:\MyDirectory.” The command line processor expands the macro by replacing it with “c:\MyDirectory.” The batch file now looks like this:

Dir c:\MyDirectory

MyProgram.exe

The batch file can now be executed properly.

A command line language that may be used in an embodiment of the invention will now be described. The language is made up of tags and macros. A tag is a unit of execution that can involve a program or function to perform a task. The syntax is as follows:

<#tag_type [command] [optional parameters]/#>

where tag_type describes type of tag (for example, command, special directive, etc.), command defines the command to be executed in this tag, and optional parameters are a list of optional parameters with special meaning for tag/command.

Examples of possible tags include:

<#CMD timeout=100, runas=thisUser, run-my-test param1 param2 param3/#> After parsing this command line, the command line processor executes ‘run-my test param1 param2’ under the credentials of user ‘thisUser’ with a timeout set to 100 milliseconds.

<#Directive reboot, require_confirm=yes/#>

This command reboots the computer with user confirmation.

<#SCRIPT[parameter]

. . .

/#>

This tag contains script to be executed by external scripting engine.

Macros are tokens that are replaced by strings when parsed. In this embodiment, macros can be embedded, so that, for example, one macro can include another macro. Also, recursive executions allow one macro to generate another macro, giving this language implementation the flexibility of run-time generated code

The syntax for macros is as follows:

<$macro_type [parameters]>

If the command line processor is implemented as a multi-pass processor, the “parameters” in this tag may include a code for telling the processor the phase in which the macro is to be expanded.

Examples of possible macros include:

<$DLL-special.dll EntryPoint=FuncParam, param=“local”, timeout=30>

The “DLL” macro specifies which DLL (dynamic-linked library) is to be loaded, and which functions within the DLL are to be called. In this case, the DLL “special.dll” will be loaded. Then, the function FuncParams called using the parameter “local.” The timeout is set to 30 seconds. The function called (e.g. FuncParam) may return a character string that will be used by the command line processor to replace the macro.

<DGX=Enter file name:, type=F, timeout=30, default=“file.txt”>

When the command line processor expands the “DGX” macro, it displays a dialog box with a prompt and a default value. In this case, the dialog box will have the prompt ‘Enter file name’ with edit box containing default string ‘file.txt.’ The dialog box will be displayed for 30 seconds if user does not edit it, based on the timeout parameter. The parameter “Type” value being entered. In this case, the value entered is of type “F,” which signifies that it is a filename. This tells the command line processor to enable and process “Browse” button in dialog box. Other possible file types include, but are not limited to: T (text), N (number), and P (password). The command line processor may modify its functionality based on type of value entered.

An example of a command line that uses a macro in accordance with an embodiment of the invention is as follows:

<#CMD run-my-test. Exe <$DGX=Enter file name:, type=F, default=“test.txt”>/#>

When the command line processor encounters this command line, it displays dialog box with the edit box pre-filled with “test.txt.” The “Browse” button will also be enabled. After the user edits the text, the dialog box is dismissed and value macro is replaced with the value entered by the user. The resulting command line, assuming that the default is used, is as follows:

run-my-test.exe test.txt.

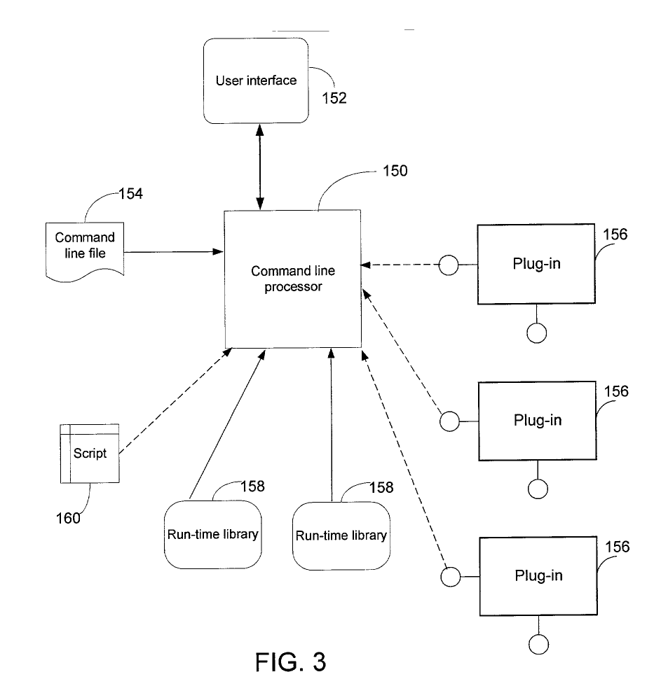

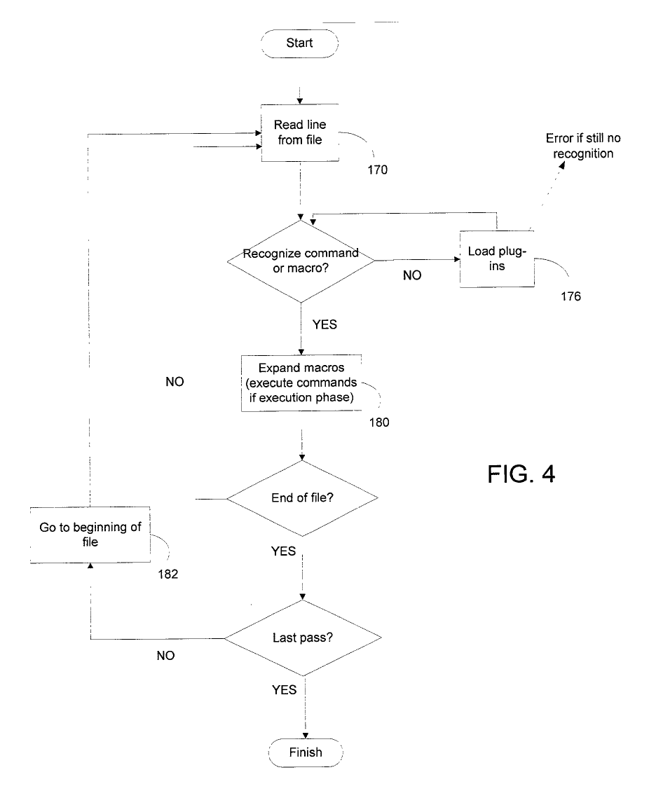

A software architecture that may be used to implement on embodiment of the invention will now be described, with appropriate reference to FIGS. 3 and 4. The architecture includes a command line processor 150, a set of optional plug-ins 156, run-time libraries 158, optional script 160 and a user interface 152. A command line file 154 contains a series of command lines, included macros, where appropriate. The processor 150 receives the command line file 154 as input and parses its contents. The processor 150 is capable of understanding and interpreting a number of tag and macro types. However, this embodiment of the invention is extensible in that it allows programmers to define their own tags and macro types through the addition of one or more plug-ins 156. When the processor 150 encounters a tag or macro that it does not recognize, it calls the appropriate plug-in to assist in the parsing process. The run time libraries 158 contain functions that can be called by the processor 150 in response to the appropriate macro. If required the processor 150 may invoke one or more scripts 160 by sending then to an appropriate scripting engine in response to the appropriate macro or macros. Finally, the processor 150 receives input from a user (from a dialog box, for example) via the user interface 152. The user interface 152 may also be used to display messages and results to the user.

Referring to FIG. 4, an example of a procedure that may be followed by the command line processor 150 will be now described. In this procedure, the processor 150 processes the command line file 154 in at least two passes. The first pass is referred to as the “schedule phase” and the second pass is referred to as the “execution phase.” At step 170, the processor reads a line from the file. If the processor does not recognize either command tag or a macro in the command line, the flow moves to step 176, at which the processor loads the plug-ins 156. If, after loading the plug-ins 156, the processor 150 still cannot recognize one or more tags or plug-ins, the processor ends with an error. If the processor 150 recognizes all of the commands and macros, the flow moves to step 180, at which the processor 150 processes the command line expanding macros as necessary, and, if it is the execution phase, executing the commands. If the processor has reached the end of the command line file 154 and there are no more passes, the procedure ends. Otherwise, the procedure returns to step 170.

The processor goes through the entire file once for the schedule phase and once for the execution phase. The processor determines whether a macro line is to be expanded during the schedule phase or during the execution phase based on optional parameters that may be included with the macro. This allows macros to be nested. For example, if a programmer wishes to have the user type in, at runtime, the name of a DLL to be used to generate a macro, he could structure a command line as follows:

<#CMD dir <$DXS ‘Enter name of DLL’>

When the processor sees this command line, it knows that it is supposed to expand the “$DX” macro in the scheduling pass, since there is an “s” immediately after the macro name. Thus, during the scheduling pass, the processor 150 prompts the user to enter the name of the DLL. If the user enters “MyDLL.dll,” the processor expands the macro so that the command line reads;

<#CMD dir <$DL MyDLL.dll>/#>

On the execution pass, the command processor runs MyDLL.dll to obtain the correct directory and expand the $DL macro so that the command line appears as follows just before it is executed:

<#CMD dir c:\MyDirectory/#>

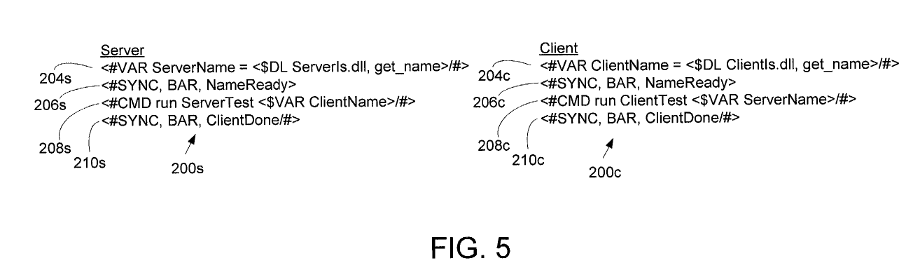

Referring to FIG. 5, an example of a scenario in which an embodiment of the invention is used will now be described. In this example, it is assumed that client-server software is being tested, and that, prior to the execution of the test, a client computer and a server computer linked together in a network need to obtain their own assigned names and provide those names to one another. Command line files 200c and 200s are being processed at the client and server computer respectively. These files each include CMD tags, which have been previously discussed, as well as the tags VAR and SYNC. The VAR tag tells the command line processor to assign a value to a variable, while the SYNC tag tells the command line processor to synchronize with other processes according to a synchronization variable.

At line 204s, the command line processor running on the server first expands the <$DL ServerIs.dll, get_name> macro. This involves calling the “get_name” function of ServerIs.dll to obtain a character string. Once the processor has received the string as a result of the function call it replaces the macro with the result, which, in this case, is the name of the server. At line 206s, the command line processor on the server waits at a barrier for the client to complete lines 204c and 206c, as indicated by the synchronization object “Name Ready.” At line 208s the command line processor expands the macro <$VAR Client Name> by substituting the value for Client Name obtained in line 204c on the client. The processor then executes the server side of the test using the client name at line 208s. At line 208c, the command line processor running on the client performs the equivalent procedure and obtains the value for Server Name. At lines 210s and 210c, the server and client both wait for the other to be finished. At the end of this example, the server and client have each performed their respective parts of the test using each other's name.

The invention may advantageously be employed in a software testing environment. Companies that produce software may have scores of test engineers organized into various testing groups. When developing software tests, the test engineers may make certain assumptions regarding the software environment, the hardware and other variables. As tests are re-used over time and among different groups, many of these assumptions may not hold true. The embodiments of the invention described herein may be used to allow “on-the fly” modification of these variables without requiring engineers to write completely new tests. For example, a test procedure may have been developed and compiled into “test.exe.” However, the original developer of the test might have assumed that the test would be run from the “c:” drive in a directory containing the files “file1.inf” and “file2.lib.”

The developer may also have assumed that the results would be stored as a text file called “log.txt.” However, when the test is passed to a different test group, it may be run from the “m:” drive in a directory that does not contain “file1.inf” and “file2.lib.” Furthermore, the new group may want the results stored as an HTML file. Instead of rewriting the rest, the developer could simply put the test execution command line in a file along with other command lines that contain macros for allowing the new group to specify these variables when the test is run. The file might be structured as follows:

1. Pre-process: macros that allow group to specify directory and import file1 and file2.

2. test.exe.

3. post process: macros that allow group to specify test log format.

It can thus be seen that a new a useful method and system for processing input from a command line interface has been provided. In view of the many possible embodiments to which the principles of this invention may be applied, it should be recognized that the embodiments described herein with respect to the drawing figures is meant to be illustrative only and should not be taken as limiting the scope of invention. For example, those of skill in the art will recognize that the elements of the illustrated embodiments shown in software may be implemented in hardware and vice versa or that the illustrated embodiments can be modified in arrangement and detail without departing from the spirit of the invention. Therefore, the invention as described herein contemplates all such embodiments as may come within the scope of the following claims and equivalents thereof.

What is claimed is:

1. A method for processing input from a command line interface, wherein the input comprises a macro, the method comprising: replacing the macro with a command; and, executing the command.

2. The method of claim 1, further comprising prompting a user to identify the command that is to replace the macro, wherein the replacing step further comprises replacing the macro with the entered command.

3. The method of claim 1, further comprising: prompting a user to identify a function that is to be used to generate a command to replace the macro; and calling the identified function to generate the command, wherein the replacing step further comprises replacing the macro with the generated command.

4. The method of claim 1, further comprising calling a script engine to generate script to replace the macro.

5. The method of claim 1, further comprising: prompting a user to identify a script that is to be used to generate a command to replace the macro; calling the a script engine to execute the identified script to generate the command, wherein the replacing step further comprises replacing the macro with the generated command.

6. The method of claim 1, further comprising calling a function to generate the command to replace the macro, wherein the replacing step further comprises replacing the macro with the generated command.

7. The method of claim 3, wherein the function is called from a run-time library.

8. A computer-readable medium having stored thereon computer-executable instructions for performing the method of claim 1.

9. A method for processing a batch file comprising at least one macro, the method comprising: parsing the file to locate text representing the macro; expanding the macro into a command; and executing the batch file, including the command.

10. The method of claim 9, wherein the expanding step further comprises: in a first pass through the batch file, prompting the user to identify a function to be used to generate the command; replacing the macro with a second macro representing the identified function; in a second pass through the batch file, using the second macro to invoke the represented function and generate the command and replace the macro with the generated command.

11. The method of claim 9, wherein the expanding step further comprises: in a first pass through the batch file, locating a function identified by the macro; using the identified function to generate a second macro representing a second function; in a second pass through the batch file, using the second macro to invoke the second function and generate the command; and replacing the second macro with the generated command.

12. The method of claim 9, further comprising: prompting the user to input data for expanding the macro; reading a field in the macro to determine the type of data that is to be received from the user; receiving the user input; and, expanding the macro based on the determined type of data.

13. The method of claim 12, wherein, if the determined data type is a filename, providing a means for allowing the user to browse available files and select a file to be used to expand the macro.

14. A computer-readable medium having stored thereon computer-executable instructions for performing the method of claim 9.

15. A system for processing command line input, the system comprising: a command line interface for receiving the command line input; and a command line processor for parsing the command line input, identifying one or more macros within the input, expanding the one or more macros into commands, and executing the commands.

16. The system of claim 15, further comprising a plug-in module for defining at least one of the macros, wherein the plug-in module is accessible by the command line processor.

17. The system of claim 15, further comprising a run-time library having functions that are executable by the command line processor to replace at least one of the macros with a line of text.

18. The system of claim 15, further comprising a run-time library having functions that are executable by the command line processor to replace at least one of the macros with another macro.

19. The system of claim 15, further comprising: a scripting engine invokable by the command line processor; and a computer-readable medium having stored thereon a script that is executable by the scripting engine to replace at least one of the one or more macros with a line of text when the scripting engine is invoked by the command line processor.

20. The system of claim 15, further comprising a computer-readable medium having stored thereon a text file having one or more lines of commands, wherein at least one of the lines of commands includes at least one of the one or more macros.

21. The system of claim 20, further comprising a means for reading the text file.
